(19) United States
(12) Patent Application Publication
(10) Pub. No.: US 2002/0103837 A1
(43) Pub. Date: Aug. 1, 2002

(54) Method for handling requests for information in a natural language understanding system

(75) Inventors: Rajesh Balchandran, Elmsford, NY (US); Mark E. Epstein, Katonah, NY (US)

Correspondence Address: Gregory A. Nelson, Akerman Senterfitt, Fourth Floor, 222 Lakeview Avenue, P.O. Box 3188, West Palm Beach, FL, 33402-3188, US

(73) Assignee: International Business Machines Corporation, Armonk, NY (US)

(21) Appl. No.: 09/773,157

(22) Filed: Jan. 31, 2001

(51) Int. Cl. G06F 17/27

(52) U.S. Cl. 707/534

(57) ABSTRACT

A multi-pass method for processing text for use with a natural language understanding system can include a series of steps. The steps can include determining at least one contextual marker in the text and identifying a referrent in a question in the text. In a separate referrent mapping pass through the text, the method can include classifying the identified referrent as a particular type of referrent using the contextual marker and the identified referrent.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

1. Technical Field

This invention relates to the field of natural language understanding, and more particularly, to a method for understanding requests for information in a natural language understanding system.

2. Description of the Related Art

Natural language understanding (NLU) systems enable computers to understand and extract information from human speech. Such systems can function in a complimentary manner with a variety of other computer applications, such as a speech recognition system, where there exists a need to understand human speech. NLU systems can extract relevant information contained within text and then supply this information to another application program or system for purposes such as booking flight reservations, finding documents, or summarizing text.

Currently within the art, many NLU systems are implemented as directed dialog systems. Directed dialog NLU systems typically prompt or instruct a user as to the proper form of an immediate user response. For example, a directed dialog NLU system can instruct a user as follows “Say 1 for choice A, Say 2 for choice B”. By instructing the user as to the proper format for an immediate user response, the NLU system can expect a particular formatted speech response as input.

In contrast to a directed dialog NLU system, a conversational NLU system does not give a user directed and immediate guidance as to the proper form and content of a user response. Rather than guiding a user through a series of menus, such systems allow a user to issue practically any command or request for information at any time. Accordingly, a conversational NLU system must be able to understand and process those user responses at any point within a given dialog.

Typically, NLU systems can be trained using a training corpus of text comprising thousands of sentences. Those sentences can be annotated by annotators for meaning and context. Alternatively, a parsing algorithm can be used to extract relevant meaning from the training corpus. Similarly, at runtime, statistical processing methods known in the art can be used to mark the text for context and meaning.

Currently, conventional NLU systems can extract the core meaning from a text input during a main iteration through the text generally referred to as an understanding or semantic pass. Also, additional contextual markers can be determined during the understanding pass, or alternatively can be determined through one or more preprocessing steps or passes. For example, contextual markers such as classes of words can be determined. Other contextual markers can include grammatical parts of speech. In any case, regardless of any pre-processing, conventional NLU systems utilize an understanding pass, which can be trained statistically using a training corpus or can be rule or grammar based, to extract meaning from text.

One way in which a user request for information can be identified from text is to mark text passages which represent questions during the understanding pass. Portions of text identified as questions not only can be marked as such, but also can be marked as a particular type of question. Specifically, a question can be annotated as a yes or no question, denoted as a YN question, or alternatively as a who, what, where, when, why, or how question, denoted as a WH question. For example, the question “how much can I withdraw” can be identified as a WH question. The question “can I withdraw $10,000” can be identified as a YN question.

Also during the understanding pass through the text, in addition to identifying the type of question, the subject of the question or request can also be identified. For example, within the sentence “how much can I withdraw”, the NLU system can determine that the sentence is a WH question. Further, the word “much” can be interpreted as a string indicating what the user is asking. Still, to completely classify the subject of the text, the NLU system must identify a label for the string. In this case the text refers to a maximum amount of money which can be withdrawn from an account. The term “much”, however, can be used in many different contexts, and though the string typically refers to a quantity, the exact meaning cannot be determined without determining additional information from the remainder of the text phrase. For example, the phrase “how much did I withdraw” is posing a question referring to a quantity. In this case, however, the question relates to a past event rather than a future event. Still another context can be “how much is XYZ stock today” where the text refers to a quantity representing the price of XYZ stock. In both cases, however, the exact meaning attributed to the term “much” cannot be fully determined without an analysis of the remaining text of the phrase after the word “much”.

Most text parsers used to annotate sentences and process input, however, process text from left to right. Consequently, many contextual indicators such as word tense indicating whether a question relates to an old, new, or ongoing event cannot be determined until the text has been processed through one complete iteration. Thus, when such parsers identify a question indicator such as “much” indicating that the text refers to a quantity, the parser cannot determine the type of quantity until the remainder of the text is processed. As a result, question indicators such as “much” can be annotated incorrectly because a label can be misapplied before the actual context of the text phrase is determined. Further compounding potential errors is the large number of possible meanings and corresponding labels which can be assigned to question indicators within both a training corpus or a received text input.

### SUMMARY OF THE INVENTION

The invention disclosed herein concerns a method for handling requests for information in a natural language understanding (NLU) system. The invention allows annotators to mark referrents within a training corpus, while the meaning of the identified referrents can be annotated during a separate pass through the training corpus referred to as a referrent mapping pass. Thus, the referrent mapping pass, in addition to an understanding and any pre-processing passes, can facilitate more accurate annotation of a training corpus. At runtime, the NLU system can incorporate the additional referrent mapping pass to identify requests for information and label those requests. In both cases, the multi-pass system disclosed herein can produce improved NLU system performance, particularly with regard to conversational NLU systems.

For example, during an understanding pass, questions within the text can be tagged as either yes or no questions, or as who, what, where, when, why, or how questions. The referrents of the questions can be identified. Notably, the referrents can be the actual text strings identifying the subject about which the text refers. During a referrent mapping pass through the text, the specific subject referred to by the text can be identified. For example, the specific type of referrent can be determined.

One aspect of the invention can be a multi-pass method for processing text in a conversational NLU system. The method can include the steps of determining at least one contextual marker in the text and identifying a referrent in a question in the text. For example, the contextual marker can be an indicator of whether the question corresponds to an old transaction, a new transaction, or an ongoing transaction, an indicator of the tense of the question, an indicator of an action or a parameter of an action. The contextual marker also can be a grammatical part of speech wherein the part of speech can be a subject, a verb, or an object of the verb.

In a separate referrent mapping pass through the text, the method can include the step of classifying the identified referrent as one or more particular types of referrent using the contextual marker and the identified referrent. In the referrent mapping pass, the method further can include providing a probability distribution over all possible types of referrents. In that case, the particular types of referrents can be identified as having a probability at least equal to a predetermined threshold probability value. The classifying step can be performed using a lookup table of possible referrent types, maximum entropy statistical processing, regular expression matching, ordered rules, or statistical parsing.

Another aspect of the invention can include a machine readable storage, having stored thereon a computer program having a plurality of code sections executable by a machine for causing the machine to perform a series of steps. The steps can include determining at least one contextual marker in the text and identifying a referrent in a question in the text. For example, the contextual marker can be an indicator of whether the question corresponds to an old transaction, a new transaction, or an ongoing transaction, an indicator of the tense of the question, an indicator of an action or a parameter of an action. The contextual marker also can be a grammatical part of speech wherein the part of speech can be a subject, a verb, or an object of the verb.

The machine readable storage can include additional code section for causing the machine, in a separate referrent mapping pass through the text, to perform the additional steps of classifying the identified referrent as one or more particular types of referrent using the contextual marker and the identified referrent. In the referrent mapping pass, the method further can include providing a probability distribution over all possible types of referrents. In that case, the particular types of referrents can be identified as having a probability at least equal to a predetermined threshold probability value. The classifying step can be performed using a lookup table of possible referrent types, maximum entropy statistical processing, regular expression matching, ordered rules or a decision tree, statistical parsing, or any other classifier known in the art.

### BRIEF DESCRIPTION OF THE DRAWINGS

There are shown in the drawings embodiments of which are presently preferred, it being understood, however, that the invention is not so limited to the precise arrangements and instrumentalities shown, wherein:

FIG. 1 is a schematic diagram of an exemplary computer system on which the invention can be used.

FIG. 2 is a block diagram showing a typical high level architecture for the computer system of FIG. 1.

FIG. 3 is a flow chart illustrating an exemplary method of the invention.

### DETAILED DESCRIPTION OF THE INVENTION

The invention disclosed herein concerns a method for handling requests for information in a natural language understanding (NLU) system. The invention allows annotators to mark referrents within a training corpus, while the meaning of the identified referrents can be annotated during a separate pass through the training corpus referred to as a referrent mapping pass. Thus, the referrent mapping pass, in addition to an understanding and any pre-processing passes, can facilitate more accurate annotation of a training corpus. At runtime, the NLU system can incorporate the additional referrent mapping pass to identify requests for information and label those requests. In both cases, the multi-pass system disclosed herein can produce improved NLU system performance, particularly with regard to conversational NLU systems.

It should be appreciated that the term understanding pass can refer to the processing phase of an NLU system wherein the actual meaning or context of a body of text is determined at runtime. Further, the term understanding pass as used herein can include pre-processing of text and additional processing iterations of text wherein the actual meaning of the text is determined. For example, such pre-processing or additional processing of text can include identifying contextual markers. Contextual markers can include but are not limited to, groupings of related text strings called classes, indicators of whether a question corresponds to an old transaction, a new transaction, or an ongoing transaction, the tense of a question, a grammatical part of speech such as a subject, a verb, or an object of a verb, an indicator of an action, or a parameter of an identified action. Notably, an action can be any application specific user request or command, or cross application action, which can be executed. The parameters of the action provide the necessary details for executing the action. For example, the action of transferring money requires parameters for the amount of money, the source of money, and the destination of the money to be transferred.

According to one embodiment of the invention, a training corpus can be annotated wherein questions within the training corpus can be tagged as either yes or no questions, denoted as YN questions, or as who, what, where, when, why, or how questions, denoted as WH questions. After identifying the question types within the training corpus, the referrents of the questions can be identified. The referrents are the actual text strings identifying the object about which the text refers. For example, the text string “how much can I withdraw” can be identified as a WH question where the referrent is the term “much” indicating what the user is referring to in their query. Notably, other contextual information can be extracted from the text strings such as whether the text string refers to a new, old, or ongoing transaction, the subject, verb, and possible object of the verb, as well as verb tense, and actions and parameters of actions. Such contextual information further can be marked using contextual markers. Thus, in this case the sentence can be identified as asking about a future transaction.

During a separate pass through the text, referred to as a referrent mapping pass, the specific subject referred to by the text can be identified. For example, though the text refers to a quantity, the type of quantity referred to by the text has not yet been determined. Notably, the term “much” can be used to query for many different quantity types. Examples can include “how much is XYZ stock”, “how much can I withdraw”, “how much is the current interest rate”, “how much was yesterday's transaction”. In each case, the referrent “much” denotes a different specific meaning and quantity. These different specific meanings or referrent types can be referred to as QABOUTS, a shorthand for “what the question is about”. Notably, the QABOUTS can correspond to one or more NLU system variables, parameters, or algorithms. For example, in the case of an NLU system for managing financial accounts, the NLU system can include variables and algorithms for determining various types of financial information. In that case, exemplary QABOUT markers can be PRICE-OF-STOCK referring to the price of a stock, MAX-AMOUNT-WITHDRAWABLE referring to the maximum amount a user can withdraw, and AMOUT-OF-PREVIOUS-TRANSACTION referring to the amount of a previous transaction. It should be appreciated that the particular number of possible QABOUTS can be a function of the type of application to which the conversational NLU system is being applied. Accordingly, the number of possible QABOUTS is only limited by the number of possible responses and corresponding identifiable meanings which can be received by an NLU system.

The extracted contextual information can be used to limit the number of available QABOUTS which can be used to label the identified referrents. Taking the previous example, annotators can determine that the text string “how much can I withdraw” refers to a quantity, is a WH question, and pertains to a future transaction as indicated by the verb “can”. The annotators can exclude all QABOUTS which are inconsistent with the contextual information extracted from the training corpus. Thus, the quantity about which the user is asking is the maximum amount the user can withdraw. Thus, the term “much” can be marked with the QABOUT “MAX-AMOUNTWITHDRAWABLE”, a system variable. It should be appreciated that the method of annotating a training corpus of text disclosed herein can be implemented by annotators manually annotating a training corpus. The method also can be implemented using an annotation tool in a more automated fashion.

According to another embodiment, the NLU system can utilize the multi-pass method for analyzing received text inputs. Specifically, the additional referrent mapping pass can be used by the NLU system at runtime to extract meaning from received text. For example, in the understanding pass through the received text, the NLU system can first determine whether text strings identified as questions are YN questions or WH questions and further identify the referrents of the questions. Also, the NLU system can determine contextual information such as whether the user is asking about an old, new, or ongoing transaction, the subject, verb, and possible object of the verb, as well as verb tense, and actions and parameters of actions. During a referrent mapping pass through the received text, the NLU system can use the information extracted during the understanding pass to limit the available meanings of the text, or QABOUTS, from which to choose to more accurately determine the meaning of the text.

The training corpus and the received text can be processed using statistical or heuristic processing methods known in the art. For example, through analysis of large quantities of training data, a statistical parser with a decision tree can be developed which can be trained to identify particular words as referrents, word tense indicators, and YN or WH question indicators. Other known statistical processing methods such as maximum entropy, regular expression matching, word spotters, and statistical parsing also can be used. Still, a lookup table can be used to determine the particular QABOUT during the referrent mapping pass of the invention. In that case, the lookup table can contain all possible QABOUTS corresponding to identifiable referrents. Additionally, an ordered set of rules can be used. Regardless, the invention is not so limited by the particular method used to determine a meaning or extract information from the text.

The NLU system also can determine a probability distribution over all possible types of referrents or QABOUTS. For example, after associating a QABOUT with the identified referrents, a probability distribution for all of the possible QABOUTS can be determined. Notably, this step can be performed during training of the NLU system or using empirically determined data. Using the probability distribution over all possible QABOUTS, the NLU system can identify more than one possible QABOUT corresponding to identified referrents. For example, the NLU system can be programmed with a predetermined threshold value which can be adjusted as a system parameter. Thus, during annotation of a training corpus or in operation, the NLU system can return each QABOUT having a probability value greater than or equal to the threshold value. Alternatively, the NLU system can be programmed to return the n most probable QABOUTS. Further, the n most probable QABOUTS can be limited to only those QABOUTS having a probability greater than or equal to the threshold value. Regardless, the probability distribution values can be included in the lookup table or another suitable data structure.

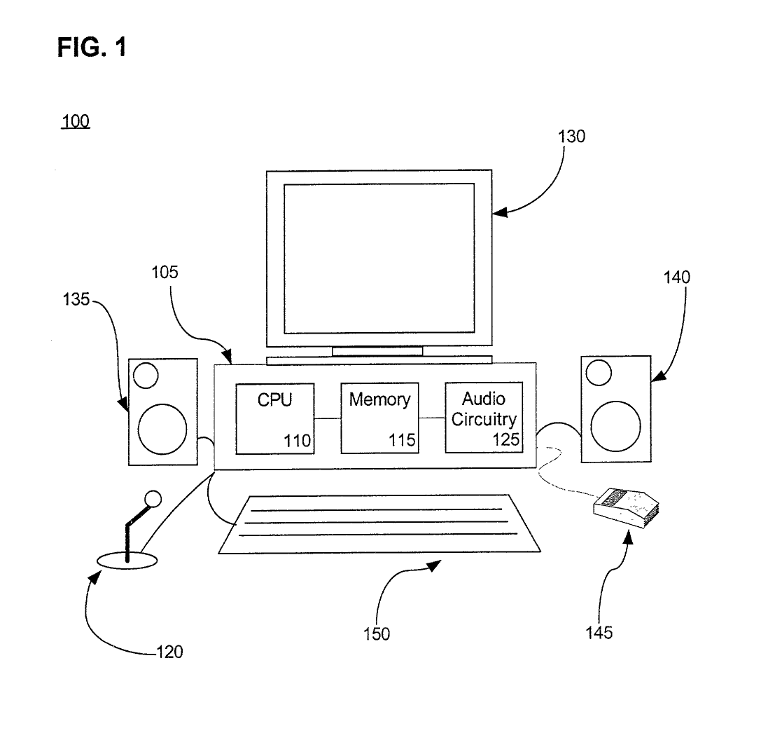

FIG. 1 shows a typical computer system 100 for use in conjunction with the present invention. The system is preferably comprised of a computer 105 including a central processing unit 110 (CPU), one or more memory devices 115 and associated circuitry. The memory devices 115 can be comprised of an electronic random access memory and a bulk data storage medium. The system also can include a microphone 120 operatively connected to said computer system through suitable interface circuitry 125, and an optional user interface display unit 130 such as a video data terminal operatively connected thereto. The CPU can be comprised of any suitable microprocessor or other electronic processing unit, as is well known to those skilled in the art. Speakers 135 and 140, as well as an interface device, such as mouse 145, and keyboard 150, can be provided with the system, but are not necessary for operation of the invention as described herein. The various hardware requirements for the computer system as described herein can generally be satisfied by any one of many commercially available high speed computers.

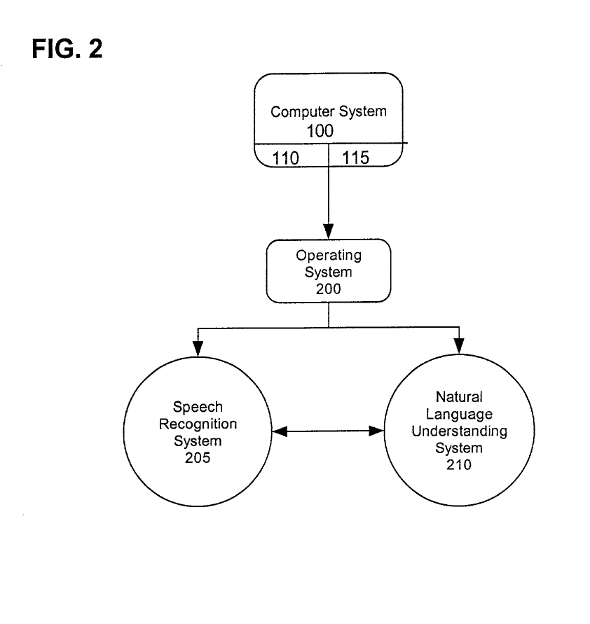

FIG. 2 illustrates a typical architecture for computer system 100. As shown in FIG. 2, within the memory 115 of computer system 100 can be an operating system 200, a speech recognition system 205, and an NLU system 210. In FIG. 2, the speech recognition system 205 and NLU system 210 are shown as separate computer programs. It should be noted however that the invention is not limited in this regard, and these computer programs could be implemented as a single, more complex computer program. For example, the speech recognition system 205 and the NLU system 210 can be realized in a centralized fashion within the computer system 100. Alternatively, the aforementioned components can be realized in a distributed fashion where different elements are spread across several interconnected computer systems. In any case, the components can be realized in hardware, software, or a combination of hardware and software. Any kind of computer system, or other apparatus adapted for carrying out the methods described herein is suited. The system as disclosed herein can be implemented by a programmer, using commercially available development tools for the particular operating system used.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

In operation, audio signals representative of sound received in microphone 120 are processed within computer 100 using conventional computer audio circuitry so as to be made available to the operating system 200 in digitized form. Alternatively, audio signals can be received via a computer communications network from another computer system in analog or digital format, or from another transducive device such as a telephone. The audio signals received by the computer are conventionally provided to the speech recognition system 205 via the computer operating system 200 in order to perform speech recognition functions. As in conventional speech recognition systems, the audio signals are processed by the speech recognition system 205 to identify words spoken by a user into microphone 120. The resulting text from the speech recognition system 205 can be provided to the NLU system 210. Upon receiving a text input, the NLU system 210 can process the received text using statistical processing methods, which are known in the art, to extract meaning from the received text input.

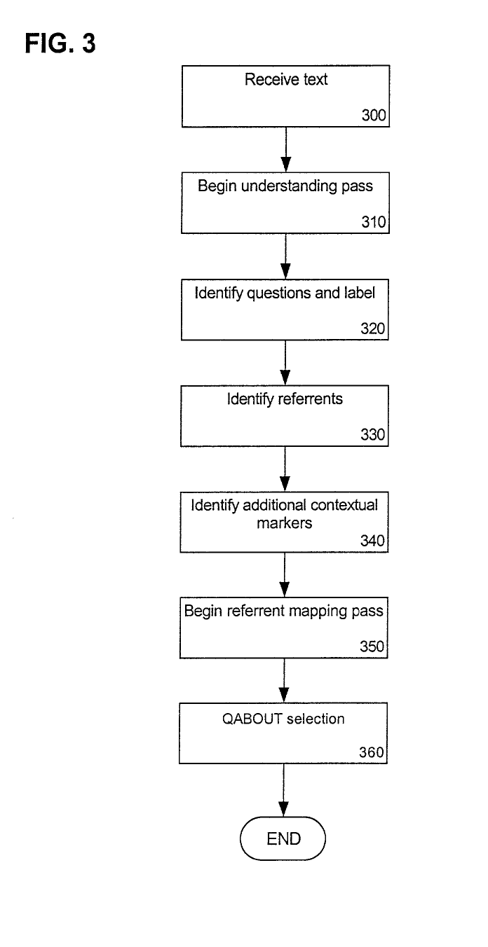

FIG. 3, is a flow chart illustrating an exemplary process for handling requests for information and for annotating a training corpus as performed by the NLU system of FIG. 2. Notably, in the latter case, the method also can be used by annotators for manually annotating a training corpus of text, or by an annotation tool for automatically annotating a training corpus of text. Specifically, FIG. 3 depicts an exemplary process for performing the understanding pass and referrent mapping pass of the multi-pass method disclosed herein. Beginning at step 300, a text input is received. In the case of realtime operation, the received text input can be text received from the speech recognition system or from another system wherein the user has manually typed text into the system. By comparison, in the case of annotating a training corpus, the received text can be a training corpus. Regardless, the received text input can be a classed input where related text strings have been identified as members of a particular class. For example, the names of particular stocks can be identified as members of a class called “STOCK” and dates can be identified as members of a class called “DATE”. Alternatively, the text input need not be classed. After completion of step 300, the method can proceed to step 310 where the method begins the understanding pass through the received text.

Continuing to step 320, questions within the received text can be identified and labeled as YN questions or WH question. More specifically, question indicators within the text can be identified and marked accordingly. For example, the word “is” can be an indication that the text phrase containing that word is a YN question rather than a WH question. Similarly, the existence of any of the terms who, what, where, when, why, or how can be an indication of a WH question. After completion of step 320, the method can continue to step 330.

In step 330, the referrent of each identified question can be identified and marked. For example, in the text phrase “how much is XYZ stock today”, the term “much” can be identified as the referrent. After completion of step 330, the method can continue to step 340.

In step 340, the NLU system can determine one or more contextual markers. For example, the NLU system can identify text strings identified as being indicators of whether a text input refers to an old transaction, a new transaction, or an ongoing transaction. Additionally, the NLU system can determine grammatical parts of speech of the text input such as nouns, verbs, and possible objects of the verbs. Moreover, the NLU system can determine verb tense. Particular text strings can be indicative of user requests for initiating actions while other text strings can be identified as parameters for those actions. Still, the NLU system can detect possessives within a text input. In any case, additional contextual markers can be identified. It should be appreciated, however, that the list of contextual markers disclosed herein is not exhaustive and the invention should not be limited only to the contextual markers disclosed herein. For example, contextual markers can be application specific and determined through empirical analysis of a training corpus. Further, it should be appreciated that contextual markers can be identified during the understanding pass as described herein or during one or more pre-processing steps or passes. For example, as mentioned, the received text can be classed text which was classed during a pre-processing step. After completion of step 340, the understanding pass of the method can be complete and the method can continue to step 350 to begin the referrent mapping pass.

During the referrent mapping pass through the received text, continuing with step 360, each labeled referrent can be classified according to the specific subject to which the identified question refers. As mentioned, each subject corresponds to a QABOUT. Thus, each labeled referrent can be classified as one or more QABOUTS.

During the referrent mapping pass of the method, a probability distribution can be provided over all possible types of referrents or QABOUTS. For example, after associating a QABOUT with the identified referrents, a probability distribution for all of the possible QABOUTS can be determined.

It should be appreciated that once a probability distribution has been determined, the NLU system can identify more than one possible QABOUT corresponding to identified referrents in step 360. For example, the NLU system can be programmed with a predetermined threshold value which can be adjusted as a system parameter. Thus, during subsequent annotations of a training corpus or in operation, the NLU system can return each QABOUT having a probability value greater than or equal to the threshold value. Alternatively, the NLU system can be programmed to return the n most probable QABOUTS. Further, the n most probable QABOUTS can be limited to only those QABOUTS having a probability greater than or equal to the threshold value.

What is claimed is:

1. In a natural language understanding system, a multi-pass method for processing text comprising the steps of:
determining at least one contextual marker in said text;
identifying a referrent in a question in said text; and
in a separate referrent mapping pass through said text, classifying said identified referrent as a particular type of referrent using said contextual marker and said identified referrent.

2. The method of claim 1, wherein said contextual marker is an indicator of whether said question corresponds to an old transaction, a new transaction, or an ongoing transaction.

3. The method of claim 1, wherein said contextual marker is an indicator of the tense of said question.

4. The method of claim 1, wherein said contextual marker is a grammatical part of speech, said part of speech comprising a subject, a verb, or an object of said verb.

5. The method of claim 1, wherein said contextual marker is an indicator of an action.

6. The method of claim 1, wherein said contextual marker is a parameter of an identified action.

7. The method of claim 1, further comprising the step of:
in said referrent mapping pass, providing a probability distribution over all possible types of referrents.

8. The method of claim 1, said classifying step classifying each said identified referrent as one or more particular types of referrent.

9. The method of claim 8, wherein said particular types of referrents have been identified as having a probability at least equal to a predetermined threshold probability value.

10. The method of claim 1, wherein said classifying step is performed using a lookup table of possible referrent types.

11. The method of claim 1, wherein said classifying step is performed using maximum entropy statistical processing.

12. The method of claim 1, wherein said classifying step is performed using regular expression matching.

13. The method of claim 1, wherein said classifying step is performed using ordered rules.

14. The method of claim 1, wherein said classifying step is performed using statistical parsing.

15. A machine readable storage, having stored thereon a computer program having a plurality of code sections executable by a machine for causing the machine to perform the steps of:
determining at least one contextual marker in said text;
identifying a referrent in a question in said text; and
in a separate referrent mapping pass through said text, classifying said identified referrent as a particular type of referrent using said contextual marker and said identified referrent.

16. The machine readable storage of claim 15, wherein said contextual marker is an indicator of whether said question corresponds to an old transaction, a new transaction, or an ongoing transaction.

17. The machine readable storage of claim 15, wherein said contextual marker is an indicator of the tense of said question.

18. The machine readable storage of claim 15, wherein said contextual marker is a grammatical part of speech, said part of speech comprising a subject, a verb, or an object of said verb.

19. The machine readable storage of claim 15, wherein said contextual marker is an indicator of an action.

20. The machine readable storage of claim 15, wherein said contextual marker is a parameter of an identified action.

21. The machine readable storage of claim 15, further comprising the step of:
in said referrent mapping pass, providing a probability distribution over all possible types of referrents.

22. The machine readable storage of claim 15, said classifying step classifying each said identified referrent as one or more particular types of referrent.

23. The machine readable storage of claim 22, wherein said particular types of referrents have been identified as having a probability at least equal to a predetermined threshold probability value.

24. The machine readable storage of claim 15, wherein said classifying step is performed using a lookup table of possible referrent types.

25. The machine readable storage of claim 15, wherein said classifying step is performed using maximum entropy statistical processing.

26. The machine readable storage of claim 15, wherein said classifying step is performed using regular expression matching.

27. The machine readable storage of claim 15, wherein said classifying step is performed using ordered rules.

28. The machine readable storage of claim 15, wherein said classifying step is performed using statistical processing.
